(19) United States
(12) Patent Application Publication
(10) Pub. No.: US 2002/0083167 A1
(43) Pub. Date: Jun. 27, 2002

(54) COMMUNICATIONS SYSTEM AND METHOD

(76) Inventors: THOMAS J. COSTIGAN, CHICAGO, IL (US); MICHAEL R. COSTIGAN, PRAIRIE GROVE, IL (US); LINDELL B. ENTZMINGER III, CHICAGO, IL (US); PHILIP A. DES JARDINS, WEST CHICAGO, IL (US)

Correspondence Address: HUTCHINS, WHEELER & DITTMAR, 101 FEDERAL STREET, BOSTON, MA, 02110, US

(21) Appl. No.: 09/167,054

(22) Filed: Oct. 6, 1998

Related U.S. Application Data
(60) Provisional application No. 60/061,166, filed on Oct. 6, 1997.

(51) Int. Cl. G06F 15/16

(52) U.S. Cl. 709/224

(57) ABSTRACT

Transactions carried out using a communications network are facilitated by systems and methods which enable representatives of a marketing party to initiate private, one-on-one communications with potential buyers. When a potential buyer expresses an interest in particular goods or services by logging onto a web site a unique identifier can be assigned to that visitor. A representative can be alerted to the presence of the visitor. Being aware of the visitor enables the representative to initiate interactive communications with the visitor. The progress of the visitor through the pages of the site can be tracked to assess the effectiveness of the site.

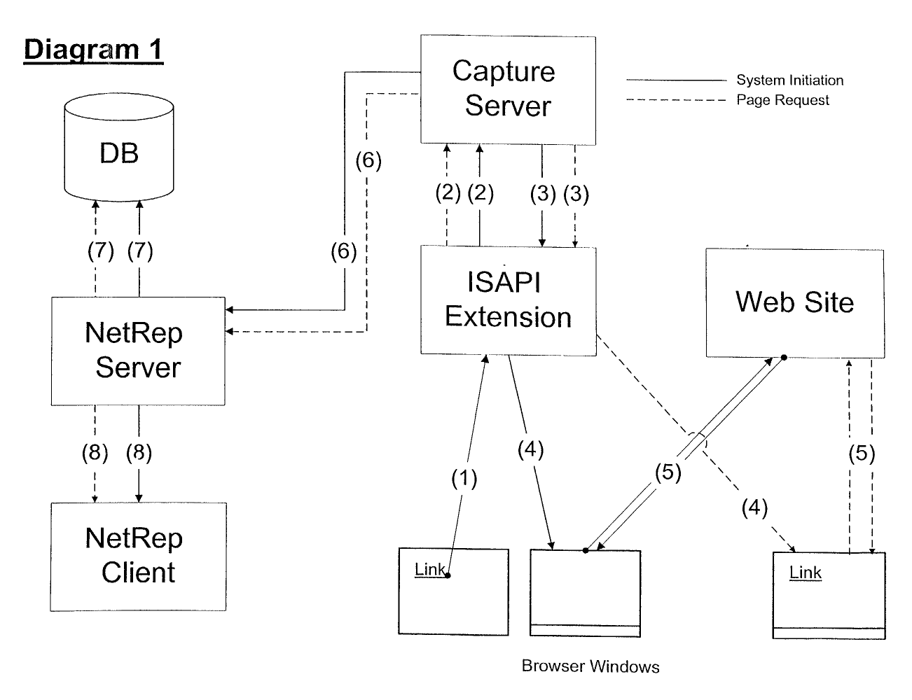

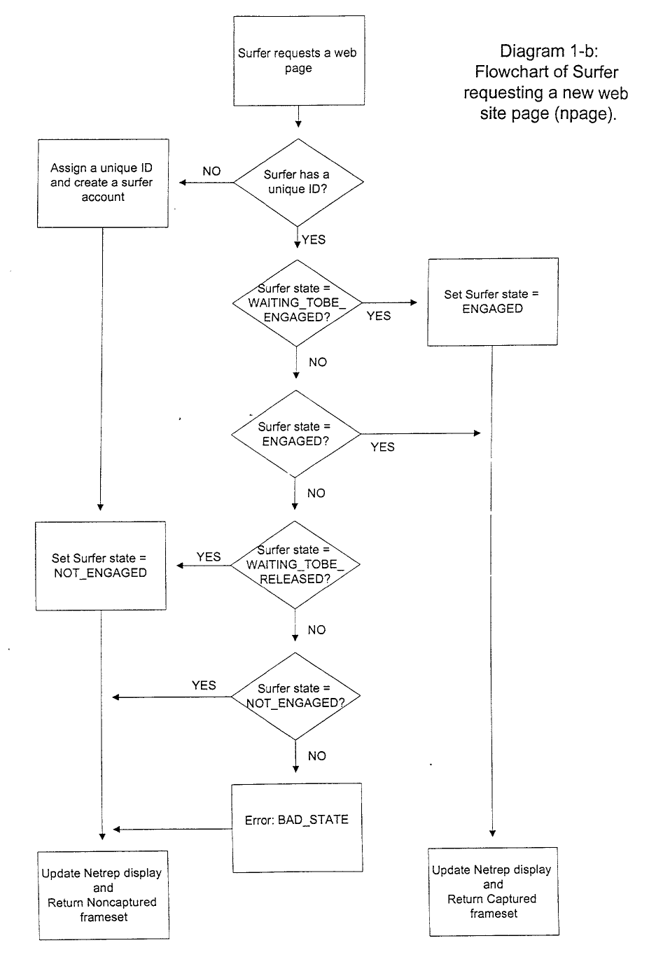

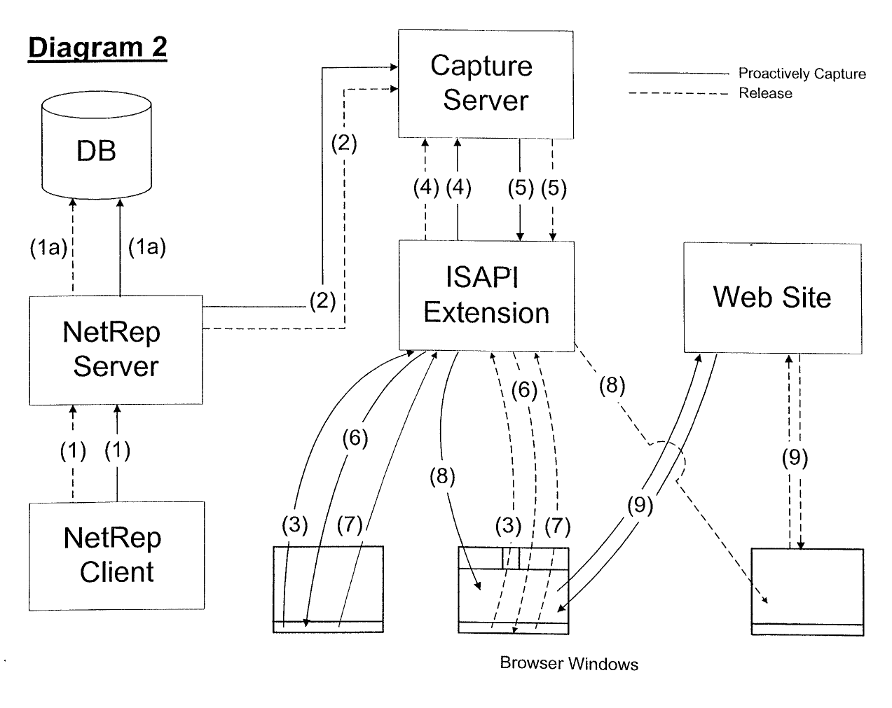

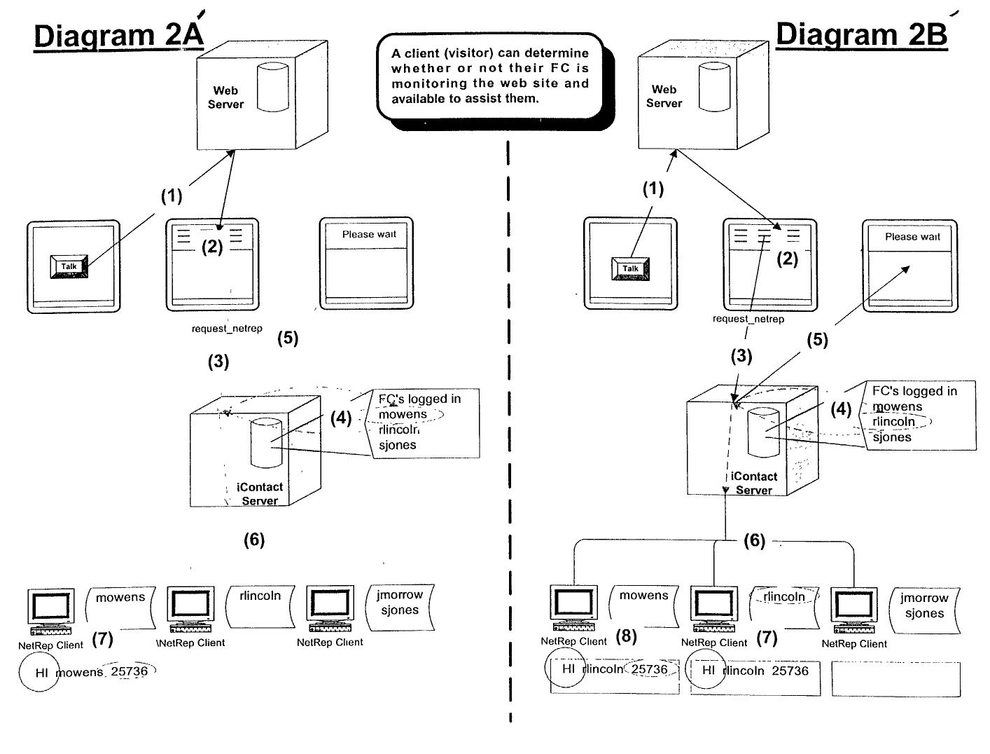

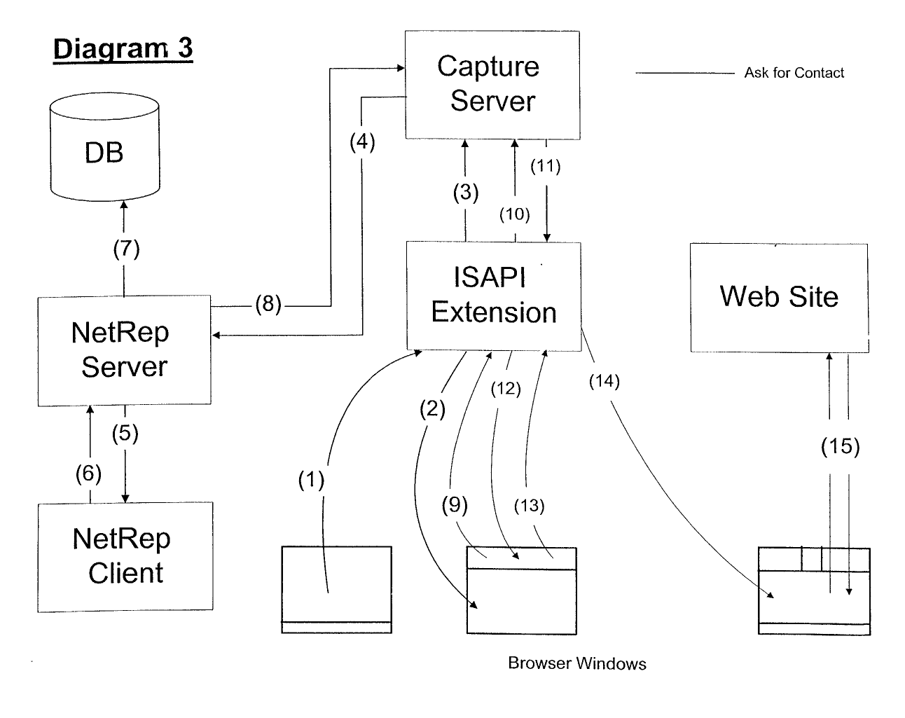

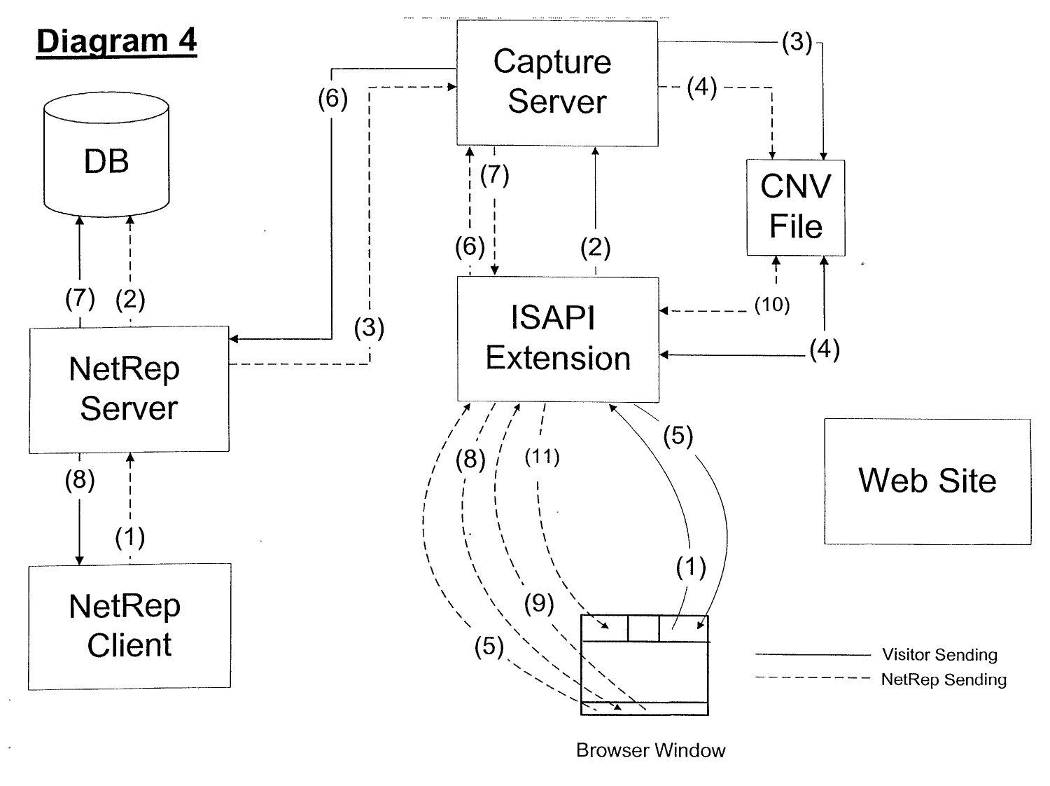

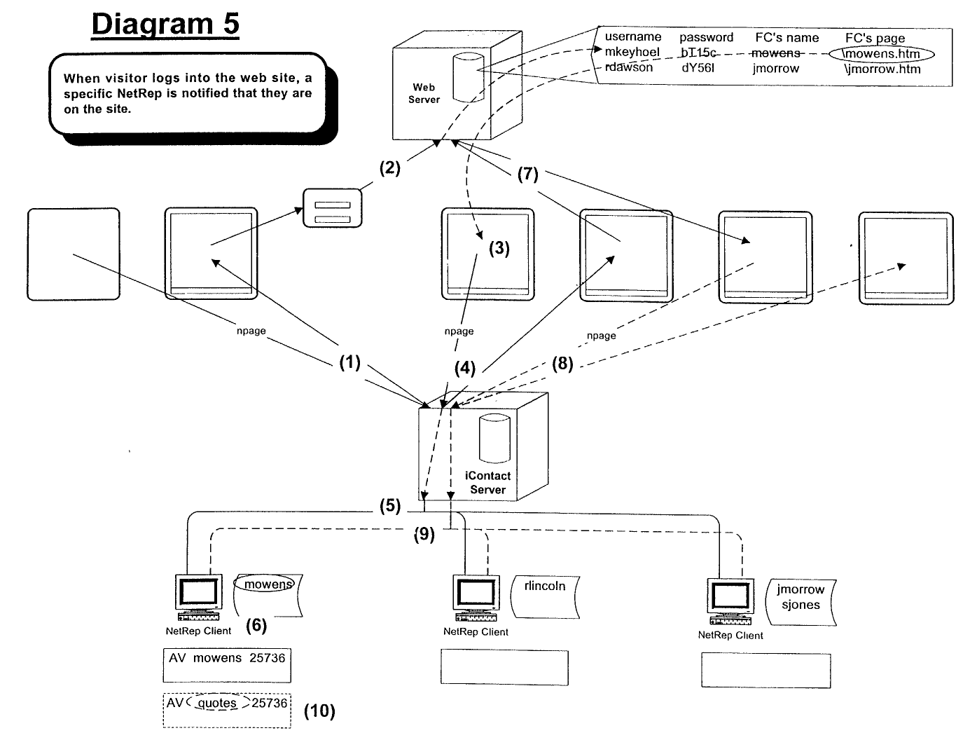

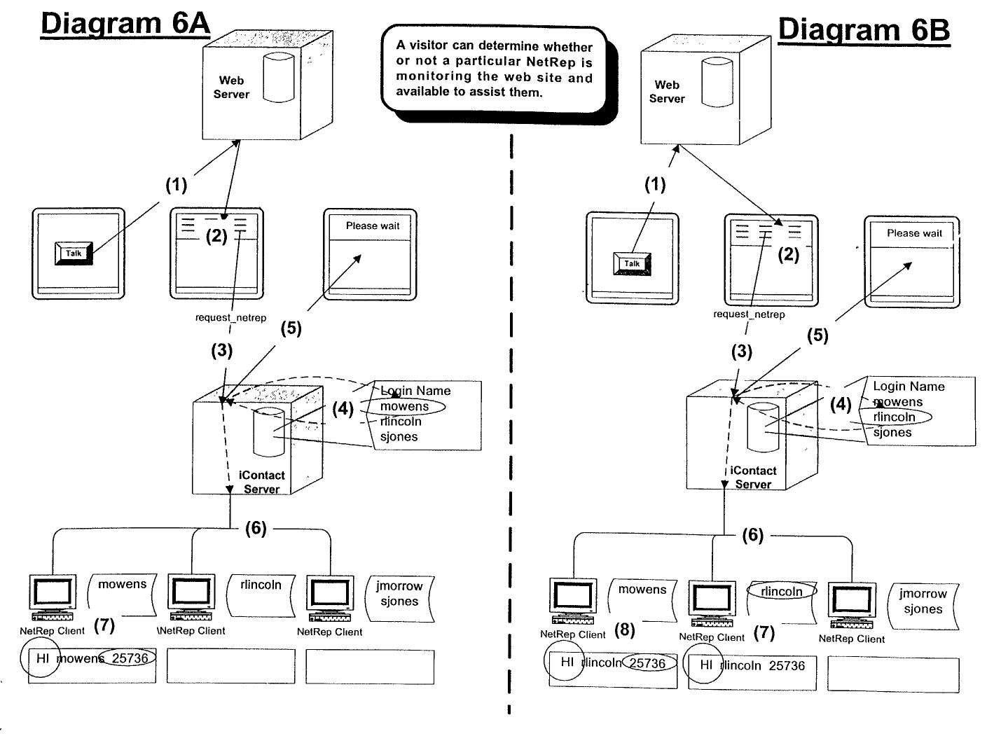

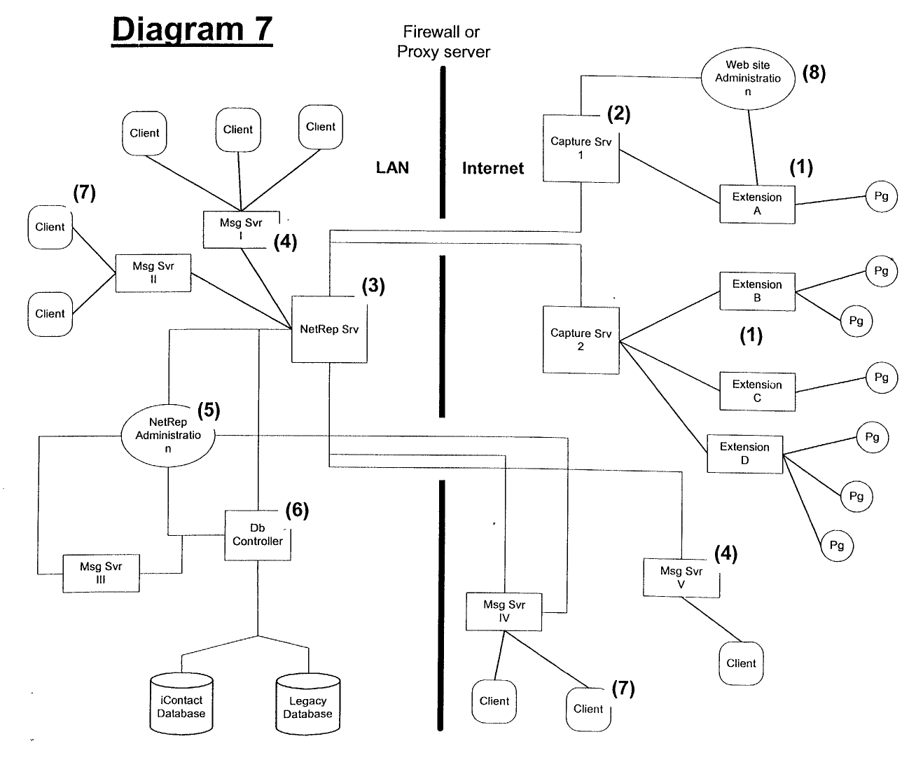

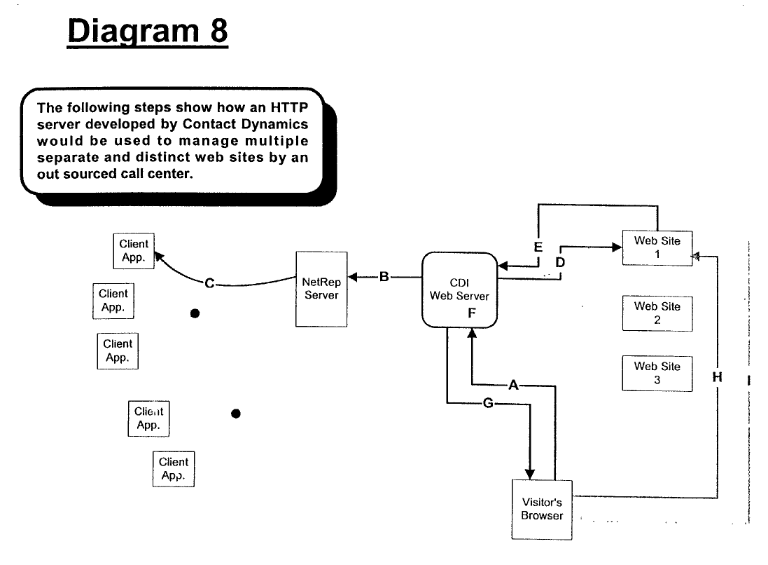

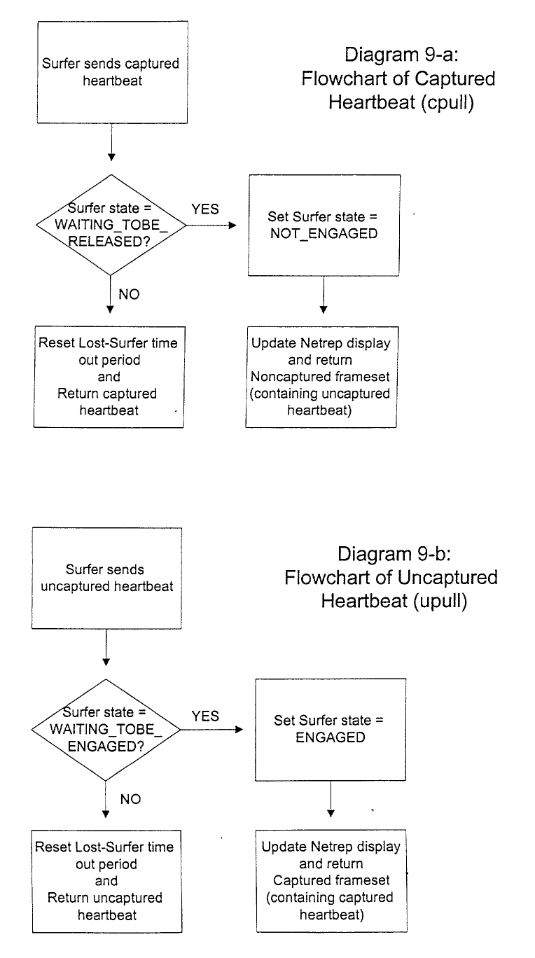

### RELATED APPLICATION

This application is a continuation-in-part of provisional application Serial No. 60/061,166 , filed Oct. 6, 1997.

### FIELD OF THE INVENTION

The invention pertains to systems and methods for facilitating interactions on communications networks. More particularly, the invention pertains to such systems and methods usable to provide interactive real time communications between a user and another party while the user is viewing a page or pages of a web site.

### BACKGROUND OF THE INVENTION

A service of the Internet, the WorldWide Web, has evolved as a readily available source of worldwide information. In addition to merely providing information, numerous companies have established web sites through which are offered a variety of goods and services.

A visitor perusing a page or pages of a selected site selects those goods or services of interest and arranges to pay for them using a credit or debit card for example. While there has been great interest in this form of electronic commerce and many companies have established web sites for the purposes of marketing their products and services, some limitations have been encountered.

One limitation that has been encountered has been an inability of visitors, who have expressed an interest in the products or services by their presence at the site to easily obtain answers to questions about the products or services. Another limitation that has been noted is an inability of the organization whose web site is being viewed to monitor the progress of the user and to initiate communication, substantially in real time, with the user during the viewing session.

In known systems, it has been necessary for the site visitor or potential customer to initiate an interaction. Not all visitors take this step.

Another form of known, interactive, network based communications is the so-called chat room. Chat rooms enable individuals having a common interest to interact substantially in real time concerning any subject that might be of interest to them. While facilitating interactive communications, chat rooms have not as yet had a substantial effect on web based commerce. One reason for this may be that persons visiting chat rooms may not have any interest at that time in buying goods or services of a type associated with the chat room. A second reason may be that chat rooms are multi-person forums that do not readily lend themselves to 1:1 interactions. Another reason is that a user must take steps to join a chat room in order to participate. A monitoring party could not bring a visitor into a chat room to initiate an interaction.

There thus continues to be a need for interactive communications capabilities which can be used to facilitate web based commerce. It would be desirable to enable a site representative to proactively engage a visitor. It would also be desirable if such capabilities could be incorporated into web sites or pages which offer goods or services. In a preferred system, it will not be necessary to download to the user any applets, “cookies”, software modules or the like. Preferably, such interactive communications could be implemented using, at the user's site, nothing more than a standard commercial browser such as those available from Microsoft Corporation or Netscape.

### SUMMARY OF THE INVENTION

The presence of a visitor at a web site that offers goods or services is an indication that the visitor is interested enough in the goods or services to be a potential customer. This is a self-screening process. In effect, the visitor's presence is a statement of interest in the subject goods or services.

The visitor's presence at a given commercial site is also a statement that “this is a good time” to consider obtaining the offered goods or services. In accordance with the present invention, a representative of a web site is provided with the tools to proactively contact a visitor in an appropriate business-like fashion to open an interactive dialog to offer to assist or help the visitor by answering questions or offering suggestions. The dialog can be carried out interactively in real-time.

The proactive capability is analogous to having a knowledgeable sales person approach and initiate a dialog with a potential customer in a store. Questions can be answered and additional suggestions can be made to the customer in real-time.

Systems and methods for facilitating electronic commerce make it possible for a visitor who has access to a web site to review the pages of that web site. While reviewing the pages, the visitor can be contacted by a representative of the proprietor of the site for purposes of initiating an interactive interchange, a conversation, with that visitor. The present systems and methods make use of the frame-based functionality of the visitor's browser. No applets, cookies, modules or other software need to be downloaded to the visitor's computer.

In another aspect, the visitor's movement through the pages of the site can be tracked and recorded. The list of tracking information for respective visitors can be stored for later review and follow-up. The tracking information can be presented in real time to the representative to facilitate the communications process.

In yet another aspect, a dialogue box can be opened on the visitor's display for purposes of initiating a text-based interactive conversation. At the initiating end of the conversation, a display can be provided of both sides of the conversation.

Alternatively, a graphical symbol or icon can be provided on the visitor's display. Triggering or clicking on the symbol or icon enables the visitor to open a conversation with a representative of the site. The representative can then respond to the visitor's inquiries on a real time basis. Specific questions can be answered and any concerns raised by the visitor about the goods or the services can be addressed immediately.

In yet another aspect, the present systems and methods can be implemented with respect to web sites that use HTML coded pages. This implementation, which makes use of HTML frame tags supported by currently available browsers, is especially desirable. Only the pages associated with a selected web site need be supplemented with additional frame and link tags. No applets, “cookies” or other modules need be downloaded to the visitor's computer. All that is required at the visitor's end is that the respective browser be capable of responding to frame tags.

In yet another aspect, where a visitor logs onto a web site a unique identifier is assigned to that visitor. This identifier can be used to track the progress of the visitor through the pages of the site. Unlike an IP address which can be associated simultaneously with a plurality of visitors to the site, the unique assigned identifier enables a representative of the site to initiate a 1:1 interactive conversation with the visitor.

The unique identifier also enables a web site proprietor to analyze either in rea time, or, off line patterns of usage of the site. High traffic, commercially effective paths can be identified and emphasized. Low traffic paths can be revised or discontinued.

Exemplary applications of the invention include:

Providing a live sales person in the internet.

Example: A jewelry sales web site, where the site is organized to lead the visitor to one of a number of product categories (for example, rings, watches, necklaces, etc.). Sales oriented representatives watch the visitors move through the site. Once a visitor lingers on a product page for more than 3 minutes, a representative engages that visitor and offers assistance. If the visitor responds favorably, the representative attempts to close a sale. If the visitor requests to be left alone, the representative terminates the conversation.

Matching a user who has a specific question with an expert representative.

Example: A technical support web site, where the site is organized to lead the visitor through a series of choices defining the nature of the visitor's problem before presenting a button encouraging the visitor to “Click here to speak to a live support representative”. When the visitor clicks on the button, a pool of support representatives is notified of the contact request. Each representative views the visitor's page history to determine the nature of the problem, and the representative most familiar with the problem engages the visitor. The representative and the visitor hold a text-based conversation regarding the problem, and once it is solved, the Representative terminates the conversation.

Matching the correct regional sales agent with the correct customer.

Example: A property rental web site monitored by three pools of representatives, each with a geographic area to service. The web side is organized by location (North, Central, and South) and each area is subdivided by property type (house, apartment, office). Each representative monitors only the portion of the web site which corresponds to their geographic region. As the visitor moves throughout the pages on the site, the appropriate representative is able to watch the visitor's page selections and engage that visitor already knowing that the visitor wants, for example, a 3-bedroom apartment in the Central region.

Correct and validate the customer choices in a user-configurable product order system.

Example: A computer sales web site where web visitors configure the system they wish to purchase. The visitor selects the components they want, then submits the list to a validation program. If the validation program categorizes the system as poorly designed, a representative notified and engages the visitor in a conversation to talk them through and correct their choices.

Numerous other advantages and features of the present invention will become readily apparent from the following detailed description of the invention and the embodiments thereof, from the claims and from the accompanying drawings.

### DETAILED DESCRIPTION OF THE PREFERRED EMBODIMENTS

While this invention is susceptible of embodiment in many different forms, there are shown in the drawing and will be described herein in detail specific embodiments thereof with the understanding that the present disclosure is to be considered as an exemplification of the principles of the invention and is not intended to limit the invention to the specific embodiments illustrated.

### EXEMPLARY CONVERSATION

N - Representative of Site
S - Visitor at Site

| MESSAGE TEXT | SENDER | TIME & DATE |
|---|---|---|
| Hi, I'm Sue with Contact Dynamics. I'm here live, can I help you? | N | 8/5/98 5:33:39 PM |
| Good evening! | N | 8/5/98 5:34:04 PM |
| If you look to your right and touch compose message and begin typing in | N | 8/5/98 5:34:09 PM |
| the box, we can talk. | | |
| I'm just trying this out as a demo. You probably get that a lot. | S | 8/5/98 5:34:48 PM |
| ShopcyberMall, so nice of you to visit!! | N | 8/5/98 5:35:20 PM |
| Thanks. We are currently using live chat on our web site, but we had | S | 8/5/98 5:36:02 PM |
| someone email us to look at you guys. | | |
| Yes, I do, and it's my job, so I never mind. BTW, you have the hands | n | 8/5/98 5:36:07 PM |
| down coolest catalog!! That's the consensus from our office!! | | |
| That was me. | N | 8/5/98 5:36:16 PM |
| Thanks!! | S | 8/5/98 5:36:25 PM |
| No live chat, this is a powerful sales tool and lead generator, | N | 8/5/98 5:36:36 PM |
| There are two models of Contact. Inbound and Outbound. I use both at | N | 8/5/98 5:38:53 PM |
| the same time. | | |
| Outbound allows you to see the surfers on the site, where they are, and | N | 8/5/98 5:39:17 PM |
| how long they stay. With Outbound you can initiate a conversation with | | |
| any surfer at any time. This is how I saw you enter the site and how I | | |
| captured you!! It is unique to us alone. | | |
| How are you saying that? How is this different from Interactive Express? | S | 8/5/98 5:39:21 PM |
| 70% of all people who engage your commerce server do not finish the | N | 8/5/98 5:39:48 PM |
| transaction. Our software can make a difference. | | |
| Okay, but how is this different from your competitor XYZ's | S | 8/5/98 5:40:25 PM |
| They can't engage a surfer. They have to wait for a request for | N | 8/5/98 5:40:27 PM |
| assistance. We don't wait!! | | |
| Oh, I see, When would you feel it necessary to interrupt a shopper? | S | 8/5/98 5:41:01 PM |
| Let me show you our interface. Click directly on the next message I send | N | 8/5/98 5:41:07 PM |
| you. | | |
| Don't' think of it as interrupting, you're assisting, just like a high line | N | 8/5/98 5:41:49 PM |
| department store would. | | |
| Plus, we don't have to download any junk into your surfers machines | N | 8/5/98 5:43:12 PM |
| No downloads, applets, cookies or plug ins | N | 8/5/98 5:43:28 PM |
| Contact is a server extension browser driven. It uses NT. We can talk | n | 8/5/98 5:43:36 PM |
| with any visitor that has a browser that was written within the last two | | |
| years. | | |
| I can conduct five individual conversations at one time on my station. | N | 8/5/98 5:43:53 PM |
| Although I can actually see thirty surfers in the queue | | |
| How do you contact them? Does a window just open up in the middle of | S | 8/5/98 5:44:11 PM |
| their visit? How can you tell who they are? | | |
| Just like what you are looking at right now!! But, it can be customized | N | 8/5/98 5:44:42 PM |
| however you would like. | | |
| I can actually see them on my side. Want to see? | N | 8/5/98 5:45:01 PM |
| Sure | S | 8/5/98 5:45:17 PM |
| I trace them to know who they are. | N | 8/5/98 5:45:22 PM |
| Go to Contact Inbound or you can just click on my message to you and it | N | 8/5/98 5:45:57 PM |
| will take you there. | | |
| <a href=“/out-zoom.htm” target “content” >Click here for a Netrep | N | 8/5/98 5:46:14 PM |
| screen shot <a> | | |
| You haven't moved yet. That's the other thing. I can see where the surfer | n | 8/5/98 5:48:03 PM |
| goes and have a history of their last ten pages that they visited. | | |
| You've got it now, and you can zoom on that picture to get a better look. | N | 8/5/98 5:57:16 PM |
| Where do you see who I am? | S | 8/5/98 5:58:07 PM |
| Lower left are the surfers, and your IP number can be traced through a | N | 8/5/98 5:59:06 PM |
| simple tracing program. I can get name and address of the company you | | |
| are with from a static server | | |
| AOL you just get numbers, can't trace those. | N | 8/5/98 5:59:20 PM |
| Figures - | S | 8/5/98 5:59:38 PM |
| The captured surfers have unique identifier numbers between the two | N | 8/5/98 5:59:56 PM |
| windows on the bottom | | |
| So, Contact Dynamics is the surfer here? | S | 8/5/98 5:59:58 PM |
| Wow - I am impressed!! | N | 8/5/98 6:00:26 PM |
| You are the first person that noticed | N | 8/5/98 6:00:39 PM |
| Don't get too excited, that's my job. | S | 8/5/98 6:00:47 PM |
| Maybe I'm the 1st person who cares. | S | 8/5/98 6:01:07 PM |
| Mine too, but it's also a lot of other peoples jobs that visit me, no one has | N | 8/5/98 6:01:34 PM |
| got it yet. You must be a woman!! Please tell me I'm right!! | | |
| Yes, you must be too. | N | 8/5/98 6:01:57 PM |
| Hooray!! | N | 8/5/98 6:01:26 PM |
| Hear us ROAR! | S | 8/5/98 6:02:46 PM |
| It's funny how this works, but I can even tell if a person is having a had | N | 8/5/98 6:03:31 PM |
| day on this. It's very intimate. The surfers get comfortable very quickly. | | |
| The response was far greater than we ever dreamed possible. | | |
| Neat. Do you have an information packet you can send to me? You have | S | 8/5/98 6:04:39 PM |
| my address . . . my name is Jane Doe. Director of commerce. Please | | |
| advise. | | |
| Yes, Jane, I do. Can you supply me with your address. I'll get it out in | N | 8/5/98 6:05:21 PM |
| a flash!! | | |
| Maybe you would even like an eval demo, huh? | N | 8/5/98 6:05:42 PM |
| I thought my address came up for you. | S | 8/5/98 6:06:12 PM |
| Yep. | S | 8/5/98 6:06:23 PM |
| Jane, I'm sorry, I did have that address. | N | 8/5/98 6:07:10 PM |
| Well, I'll send you the info and if you wouldn't mind a call from a rep, I | N | 8/5/98 6:07:39 PM |
| can get you the eval. | | |
| Okay, I'm going to go now. Phone number is 111-555-6789. I'll be out | S | 8/5/98 6:08:36 PM |
| of town tomorrow and Friday and out of the office next week Tues. and | | |
| Wed, and possibly Thur and Friday. Busy schedule! Later! | | |
| Sarah, I'm so glad you stopped by. You've been a delight! | N | 8/5/98 6:09:33 PM |
| Thanks! | S | 8/5/98 6:09:54 PM |
| FYI-Our granddaughter's name is Jane. So. we have a kinship already!! | N | 8/5/98 6:10:12 PM |

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

[image]

[image]

[image]

[image]

What is claimed:

1. A method of using a communications network comprising:
detecting the presence of a particular visitor at a particular page of a web site;
transmitting an indicator to a selected display whereupon transmission of a return message to be presented to that visitor can be initiated; and
transmitting the return message to that visitor for viewing.

2. A method as in claim 1 which includes tracking the progress of the visitor through the web site and building a list thereof.

3. A method as in claim 2 which includes transferring a response from the visitor to the display.

4. A method as in clam 3 which includes transferring a responsive reply back to the visitor substantially on a real-time basis.

5. A method as in claim 4 including enabling the visitor to carry out a commercial transaction.

6. A method as in claim 4 including facilitating the carrying out of an interactive conversation.

7. A method as in claim 2 which includes displaying a list of pages presented to a visitor over a period of time.

8. A method as in claim 7 wherein the list of pages is displayed at a displaced site.

9. A method as in claim 8 which includes presenting to the visitor an indicator whereby the visitor, when viewing a selected page, can initiate a bi-directional conversation with the displaced site.

10. A method of communicating with an individual who has logged onto a communication network comprising:
presenting at least a part of an information sequence, displayable in part, and including one or more pages that may be displayed at various times in response to commands entered by the individual;
detecting when the individual is viewing a page;
tracking the progress of the individual through a plurality of pages which are in part presentable graphically;
storing the tracking information;
transmitting, from another site, a selected communication to be presented to the individual to facilitate interaction with the page being displayed for the individual;
enabling the individual to form a responsive message; and
transmitting the responsive message to the another site for reviewing and in real-time, carrying out an interactive information interchange between the individual and the another site.

11. A method of facilitating interactive communications using a network comprising:
selecting at least one page containing displayable information and commands for implementing a display;
incorporating additional commands, which when the page is to be displayed at a requesting site, provide information to another site;
displaying the selected page in response to a user's request; and
initiating a bidirectional information interchange, on the page being displayed, using the provided information.

12. A method as in claim 11 wherein the initiating step includes opening a dialog box on the page being displayed.

13. A method as in claim 12 wherein a message can be entered into the dialog box.

14. A method as in claim 13 wherein the message can be transmitted to and displayed at another site.

15. A method as in claim 14 which includes building a list at the another site indicative of the pages displayed at the requesting site.

16. An information sequence, in part displayable for a viewer, comprising:
a text sequence to be displayed;
a sequence of display controlling commands combined with the displayable text; and
a sequence of tracking commands, combined with the displayable text whereby information pertaining to text being presented to a viewer can be presented, substantially in real-time, at a displaced location for tracking the text being presented to the viewer.

17. A sequence as in claim 16 wherein the text sequence is organized as a plurality of linked pages and wherein at least some of the pages include frame based commands for tracking.

18. A sequence as in claim 16 which includes, as commands, hypertext mark-up tags.

19. A sequence as in claim 18 which includes as tracking commands, hypertext framing tags.

20. A sequence as in claim 17 wherein the pages include, as commands, hypertext mark up tags and wherein at least some of the pages comprise hypertext frame tags.

21. A multi-processor communication system comprising:
a visitor client;
a visitor server, coupled at least intermittently to the visitor client for transferring information therebetween whereby a visitor using the visitor client and the visitor server can request a selected file, specified by the visitor;
a monitoring client;
a monitoring server, coupled at least intermittently to the monitoring client, for transferring information therebetween wherein the servers can communicate via a common network, whereby a representative using the monitoring client and the monitoring server can initiate an interactive real-time information interchange with the visitor and wherein the visitor can reply thereto on a one-on-one basis.

22. A system as in claim 21 wherein the visitor client includes, at least in part, a browser to facilitate a display of the selected file.

23. A system as in claim 22 wherein the browser is capable of interpreting HTML-type tags in the file to facilitate display thereof.

24. A system as in claim 23 wherein the monitoring server receives information indicative of the progress of the visitor in reviewing the displayed file.

25. A system as in claim 24 wherein the monitoring server includes a control program for forwarding to the monitoring client the progress indicating received information.

26. A method for using a computer to enable a web site representative to observe in real-time a web site usage profile of any one of a plurality of web site visitors and proactively to engage the visitor in a one-to-one, real-time conversation, comprising:
recording information about each visitor's usage of the respective web site including a list of the web pages the visitor has viewed and the amount of time spent on each, a unique visitor's address, a status indicator showing whether the visitor has been previously engaged by another representative, the total time the visitor has spent on the web site, and a unique identifier for each visitor;
displaying to a group of representatives the above information for the visitors to all or a selected portion of the web site in real-time;
enabling any one of a plurality of representatives to select any one of a plurality of visitors to engage in a private one-to-one conversation; and
proactively engaging the visitor so chosen in a one-to-one conversation without any action on the visitor's part.

27. A method as in claim 26 which includes:
enabling a visitor to request a conversation with a representative;
enabling one representative to engage in one-to-one conversations with a number of visitors simultaneously;
enabling the representative to send messages and other content to the visitor;
enabling the visitor to receive messages and other content from the representative;
enabling the visitor to send messages and other content to the representative;
enabling the representative to receive messages and other content from the visitor; and
enabling the representative to proactively terminate the conversation with any engaged visitor.

28. A method as in claim 26 which includes:
enabling the visitor to terminate the conversation with the representative.

29. A method as in claim 26 which includes:
recording all or part of the recorded information into a database for future use and analysis.

30. A method as in claim 26 which includes displaying for a visitor a two-part graphical display with the representative's comments at one location and the visitor's comments adjacent thereto.

31. An apparatus enabling a web site representative to observe a real-time web site usage profile of any one of a plurality of web site visitors and proactively engage a selected visitor in a one-to-one, real-time conversation, comprising:
a storage device; and
a processor connected to the storage device wherein the storage device includes a program for controlling the processor; and
wherein the processor interacts with the program to record information about each web site visitor's usage of the web site including at least a list of the web pages the visitor has viewed and the amount of time spent on each, a unique visitor's address, a status indicator showing whether the visitor has been previously engaged by another representative, the total time the visitor has spent on the web site, and a unique identifier for each visitor.

32. An apparatus as in claim 31 wherein:
the program displays to a group of representatives the information for the visitors to all or a selected portion of the web site in real time including instructions to allow any one of a plurality of representatives to select any one of a plurality of visitors to engage in a private one-to-one conversation and to proactively engage the visitor so chosen in a one-to-one conversation without any action by the visitor.

33. An apparatus as in claim 31 which includes:
commands to enable a visitor to request a conversation with a representative and to enable one representative to engage in one-to-one conversations with a number of visitors simultaneously;
enable the representative to send massages and other content to the visitor;
enable the visitor to receive messages and other content from the representative;
enable the visitor to send messages and other content to the representative;
enable the representative to receive messages and other content from the visitor;
enable the representative to proactively terminate the conversation with any engaged visitor;
optionally enable the visitor to terminate the conversation with a representative, and
optionally record all or part of the above information into a database for future use and analysis.

34. An apparatus as in claim 32 which includes:
a display device displaying information in real time including, but not limited to, a list of the web pages the visitor has viewed and the amount of time spent on each, a status indicator showing whether the visitor has been previously engaged by another representative or not, the total time the visitor has spent on the web site, and a unique identifier for each visitor.

35. An apparatus as in claim 31, wherein:
the storage device optionally store a record of all or part of the information regarding the user's web site usage program recorded by the apparatus.

36. A method for using a computer to observe a real-time web site usage profile of any one of a plurality of web site visitors, to compare that profile with a number of predefined web usage profiles which are associated with lists of actions to be performed upon a pattern, to determine if the visitor's usage profile matches any one of these predefined profiles, and to automatically perform the action associated with the matched usage profiles, comprising:
storing a number of predefined web site usage profiles;
storing and associating a list of actions with each predefined usage pattern;
recording information about each web site visitor's usage of the web site including, but not limited to, a list of web pages the visitor has viewed and the amount of time spent on each, the visitor's address, a status indicator showing whether the visitor has been previously engaged by another representative, the total time the visitor has spent on the web site, and a unique identifier for each visitor;
comparing the above information with each predefined usage profiles and their associated actions; and
executing the associated action list upon a successful match between the visitor's usage pattern and the predefined usage pattern.

37. The method of claim 36 further comprising:
inputting into the computer a number of descriptions of a web site usage pattern;
inputting into the computer a number of lists of actions to be performed by the computer;
associating each usage pattern description with at least one list of actions to be performed by the computer; and
editing and deleting the descriptions of web site usage patterns, the lists of actions, and their associations.

38. An apparatus for observing a real-time web site usage profile of any one of a plurality of web site visitors, to compare that profile with a number of predefined web usage profiles which are associated with lists of actions, to determine if the visitor's usage profile matches any of these predefined profiles, and to automatically perform the action associated with the matched usage profiles; comprising:
a storage device; and
a processor connected to the storage device;
the storage device storing:
a number of predefined web site usage patterns;
a list of actions associated with each predefined usage pattern;
a program for controlling the processor; and
wherein the processor is operative with the program to record information about each web site visitor's usage of the web site including, some or all of a list of the web pages the visitor has viewed and the amount of time spent on each, a status indicator showing whether the visitor has been previously engaged by another representative or not, the total time the visitor has spent on the web site, and a unique identifier for each visitor and wherein the program includes commands for comparing the above information with each predefined usage profile and executing the associated action list upon a successful match between the visitor's usage pattern and the predefined usage pattern.

39. The apparatus of claim 38, in which the processor is further operative with the program to:
input a number of descriptions of a web site usage pattern;
input a number of lists of actions to be performed by the computer;
associate each usage pattern description with at least one list of actions to be performed by the processor; and
editing and deleting the descriptions of web site usage patterns, the lists of actions, and their associations.

40. A method of analyzing visitor movements through a plurality of related files comprising:
tracking viewing paths of a plurality of viewers of the files; analyzing the tracking information and identifying selected file sequences which exhibit a greater incidence of viewing paths than other sequences.

41. A method as in claim 40 wherein the tracking step is carried out in real time.

42. A method as in claim 41 wherein the tracking information is stored.

43. A method as in claim 42 wherein the analyzing step is carried out relative to the stored tracking information.

44. A method of identifying a visitor at a web site comprising:
detecting the presence of an individual visitor at the site;
determining the visitor's IP address; and
assigning a unique identifier to the visitor in addition to the visitor's IP address.
